(19) United States
(12) Patent Application Publication
(10) Pub. No.: US 2004/0077389 A1
(43) Pub. Date: Apr. 22, 2004

(54) Antenna device for portable wireless terminal

(75) Inventor: Chang-Won Jang, Suwon-shi (KR)

Correspondence Address: PAUL J. FARRELL, ESQ., DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/386,000

(22) Filed: Mar. 11, 2003

(30) Foreign Application Priority Data
Oct. 22, 2002 (KR) P2002-64620

(51) Int. Cl. H04B 1/38

(52) U.S. Cl. 455/575.5; 455/575.1

(57) ABSTRACT

An antenna device for a portable wireless terminal that comprises an antenna housing including a built-in helical antenna and having a perforating hole defined in a longitudinal direction of the helical antenna; a whip antenna slidably retractable into and extendable from a terminal main body through the perforating hole; a stopper formed on a bottom of the whip antenna to provide a connection point and restrict movement of the whip antenna; and an antenna dummy extending from the stopper along the outer surface of the whip antenna in the longitudinal direction of the whip antenna. The antenna dummy is positioned in the helical antenna so as to face the helical antenna when the whip antenna is fully extended. The antenna dummy extends from the stopper of the whip antenna to increase the reactance of the stopper and to provide capacitive coupling between a helical antenna and the stopper to improve the antenna gain, which allows provision of a high quality antenna device even if the length of the antenna is restricted according to the miniaturization of the terminal.

### PRIORITY

This application claims priority to an application entitled “ANTENNA DEVICE FOR PORTABLE WIRELESS TERMINAL”, filed in the Korean Industrial Property Office on Oct. 22, 2002 and assigned Serial No. 2002-64620, the contents of which are hereby incorporated by reference.

### BACKGROUND OF THE INVENTION

1. Field of the Invention

The present invention relates to a portable wireless terminal, and more particularly to an antenna device for a portable wireless terminal.

2. Description of the Related Art

Usually, a portable wireless terminal is equipped with an antenna device to improve transmission and reception sensitivity and thereby ensure high quality telephone communication. Generally, the antenna device for the portable wireless terminal is composed of a combination of a helical antenna and a whip antenna. The helical antenna is mounted on the top of a terminal main body, and the whip antenna is mounted thereon in such a manner that it can be retracted into and extended from the terminal main body through the helical antenna. When the whip antenna is retracted into the main body, the terminal performs transmission and reception through the helical antenna, whereas when the whip antenna is extended therefrom, it is brought into contact with the helical antenna, thereby obtaining increased transmission and reception sensitivity. Accordingly, when the physical environment does not favor signal reception, such as in mountainous terrain or an underground environment, a user extends the whip antenna to increase the communication quality.

FIG. 1 is a perspective view showing a portable wireless terminal 100 equipped with a conventional antenna device 130, and FIG. 2 is a view showing the inner configuration of a part of the terminal 100 where the antenna device 130 is mounted.

As shown in FIG. 1, the terminal 100 includes a main body 101, a folder 102 rotatably coupled to the main body 101, and the antenna device 130 mounted on the top of the main body 101.

A keypad 111 and a microphone 113 are provided on a front surface of the main body 101, and a main board 103 as shown in FIG. 2 is built into the main body 101.

The folder 102 swings on its hinged axis with respect to the main body 101 to open or close the keypad 111 and the microphone 113. A display unit 121 and a speaker 123 are mounted on the folder 102.

Referring to FIGS. 1 and 2, the antenna device 130 includes an antenna housing 131 in which a helical antenna (not shown) is received, and a whip antenna 135 which is extended from and retracted into the main body 101 through the antenna housing 131. The antenna device is mounted on the top of the main body 101, and is connected to an RF unit of the main board 103 through a connection piece 105 fixedly mounted on the main board 103 and a connection end 133 mounted on the bottom of the housing 131.

Now, a conventional antenna device 300 is described in detail referring to FIGS. 3 and 4. As shown in these figures, the conventional antenna device 300 is composed of a combination of a whip antenna 321 and a helical antenna 313 that has a coil form and is built into the antenna housing 310.

A bobbin 311 is provided inside the antenna housing 310 to wind the helical antenna thereon, and a perforating hole is defined in the bobbin to provide a path along which the whip antenna 321 is retracted and extended. A connection end 315 connected to the helical antenna 313 is provided on the bottom of the antenna housing 310. The connection end 315 is made of a conductive material and provides connection between the helical antenna 313 and the main board (not shown). The perforating hole reaches the bottom of the connection end 315.

An antenna top 325 mounted on the top of the whip antenna 321 prevents the whip antenna 321 from fully entering the terminal main body below the top of the antenna housing 310, whereas a stopper 323 mounted on its bottom prevents the whip antenna 321 from fully exiting the terminal main body above the top of the antenna housing 310. When the whip antenna 321 is extended from the main body as shown in FIG. 4, the stopper 323 made of a conductive material is fully inserted into the connection end 315, providing electrical connection between the whip antenna 321 and the main board. The whip antenna 321 is coated with an insulating material, and also protected by a guide tube 331 extending from the connection end 315.

Meanwhile, in order to ensure stable transmission and reception, it is necessary to secure the length of the antenna to be a quarter as long as the wavelength of a used communication frequency. However, as terminals become smaller, the length of the antenna device becomes shorter, making it difficult to secure a sufficient length of the antenna, in result, causing a loss of gain of the antenna. Even in the case of a terminal securing a sufficient antenna length, in order to improve the gain of the antenna, it is necessary to repeatedly perform tests for improving the characteristics of the terminal, causing an increase of cost.

### SUMMARY OF THE INVENTION

Therefore, the present invention has been made in view of the above problem, and it is an object of the present invention to provide an antenna device of a portable wireless terminal having an improved antenna gain.

In accordance with one aspect of the present invention, the above and other objects can be accomplished by the provision of an antenna device for a portable wireless terminal comprising: an antenna housing including a helical antenna formed therein in a longitudinal direction of the antenna housing and having a perforating hole defined in a longitudinal direction of the helical antenna; a whip antenna being slidable to be retracted into a terminal main body and extended therefrom through the perforating hole; a stopper formed on a bottom of the whip antenna to provide a connection point and restrict a movement of the whip antenna; and an antenna dummy extending from the stopper along an outer surface of the whip antenna in the longitudinal direction of the whip antenna, said antenna dummy being positioned in the helical antenna so as to face the helical antenna when the whip antenna is fully extended.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a portable wireless terminal equipped with a conventional antenna device;

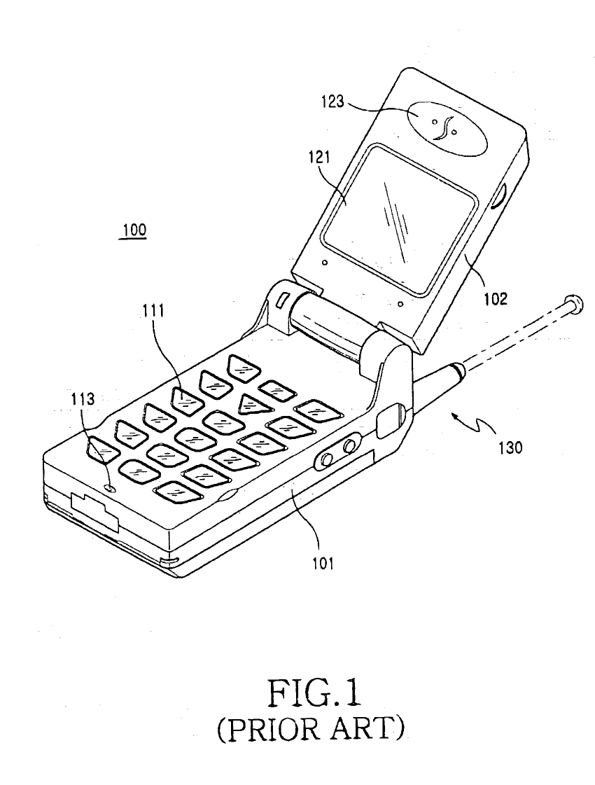

FIG. 2 is a sectional view showing the inner configuration of a part of the terminal in which the antenna device shown in FIG. 1 is mounted;

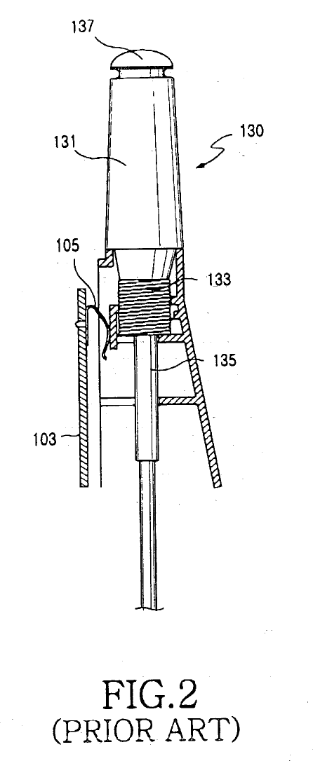

FIG. 3 is a sectional view showing an antenna device for a portable wireless terminal of the prior art;

FIG. 4 is a sectional view showing the antenna device shown in FIG. 3 when a whip antenna is extended;

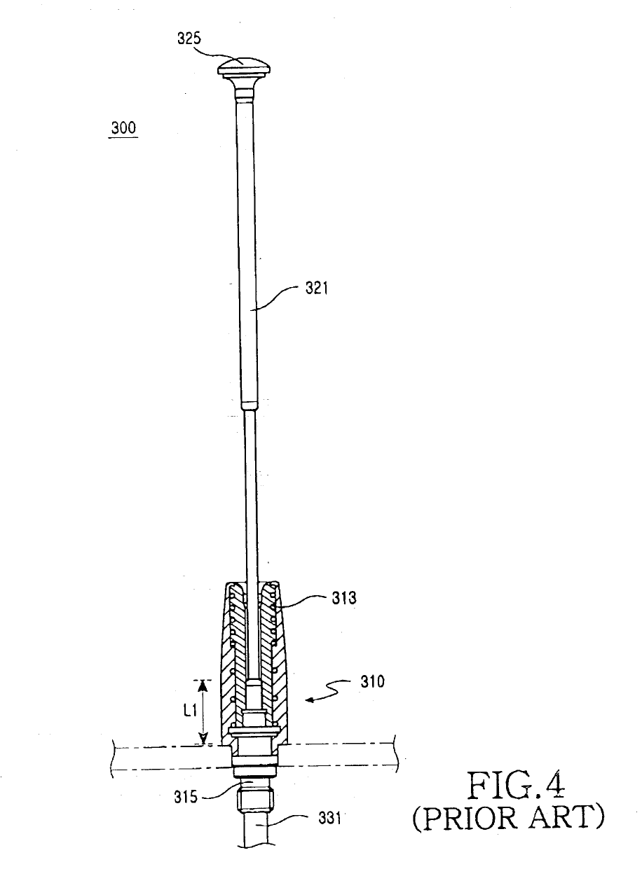

FIG. 5 is a graph showing the radiation characteristics of the antenna device shown in FIG. 3;

FIG. 6 is a sectional view showing an antenna device for a portable wireless terminal according to a preferred embodiment of the present invention;

FIG. 7 is a sectional view showing the antenna device shown in FIG. 6 when a whip antenna is extended; and

FIG. 8 is a graph showing the radiation characteristics of the antenna device shown in FIG. 6.

### DETAILED DESCRIPTION OF THE PREFERRED EMBODIMENTS

Now, a preferred embodiment of the present invention will be described in detail with reference to the annexed drawings. In the following description, a detailed description of known functions and configurations is omitted to avoid making the subject matter of the present invention unclear.

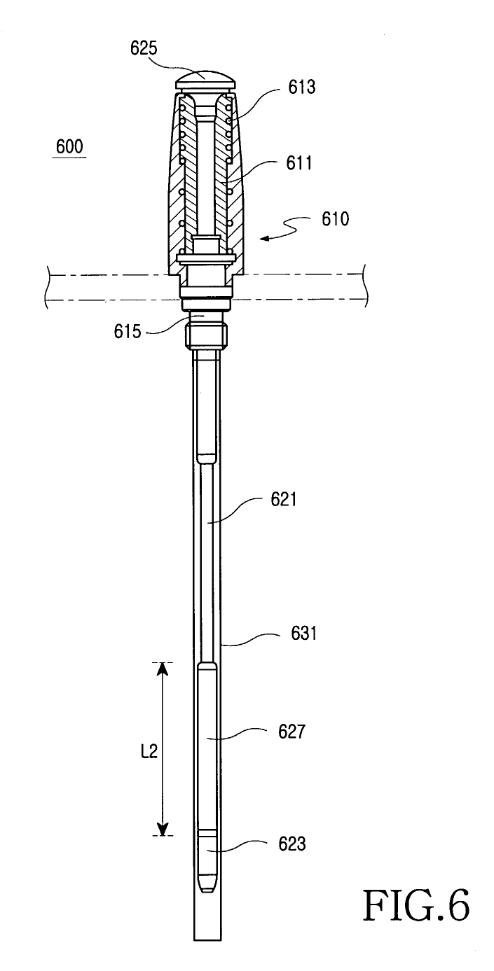

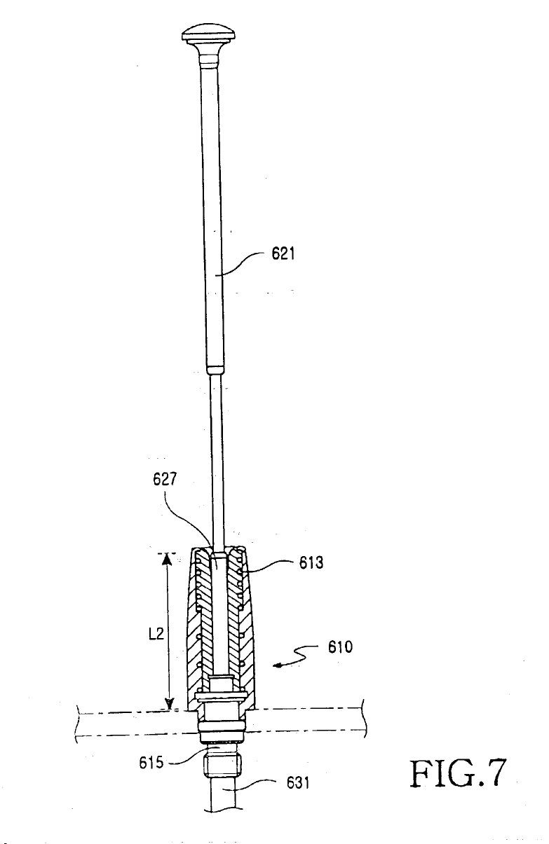

FIG. 6 is a sectional view showing an antenna device 600 of a portable wireless terminal according to a preferred embodiment of the present invention, and FIG. 7 is a sectional view showing the antenna device 600 when a whip antenna 621 is extended. As shown in FIGS. 6 and 7, the antenna device 600 is composed of a combination of the whip antenna 621 and a coil-shaped helical antenna 613 built into an antenna housing 610.

The helical antenna 613 is wound on a bobbin 611 and disposed in the antenna housing 610, and connected to a terminal main board (not shown) through a connection end 615 mounted on the bottom of the antenna housing 610. The whip antenna 621 is retracted and extended through a perforating hole defined in both the connection end 615 and the bobbin 611. An antenna top 625 is mounted on the top of the whip antenna 621, and a stopper 623 is mounted on its bottom in order to prevent the whip antenna 621 from being excessively retracted into the terminal main body and extended therefrom, respectively. The stopper 623 of the whip antenna 621 is made of a conductive material, and the connection end 615 provides connection between the whip antenna 621 and the main board.

According to the present invention, the antenna device 600 is provided with an antenna dummy 627 that extends from the stopper 623 mounted on the bottom of the whip antenna 621 and has a predetermined extension length. The antenna dummy 627 extends along the outer surface of the whip antenna 621 in a longitudinal direction. Preferably, as shown in FIG. 7, the antenna dummy extends to such a length that it reaches the top of the helical antenna 613 built into the antenna housing 610 when the whip antenna 621 is extended. The antenna dummy 627 has a diameter corresponding to the perforating hole of the bobbin 611, so as to stably hold the extended whip antenna 621 in place.

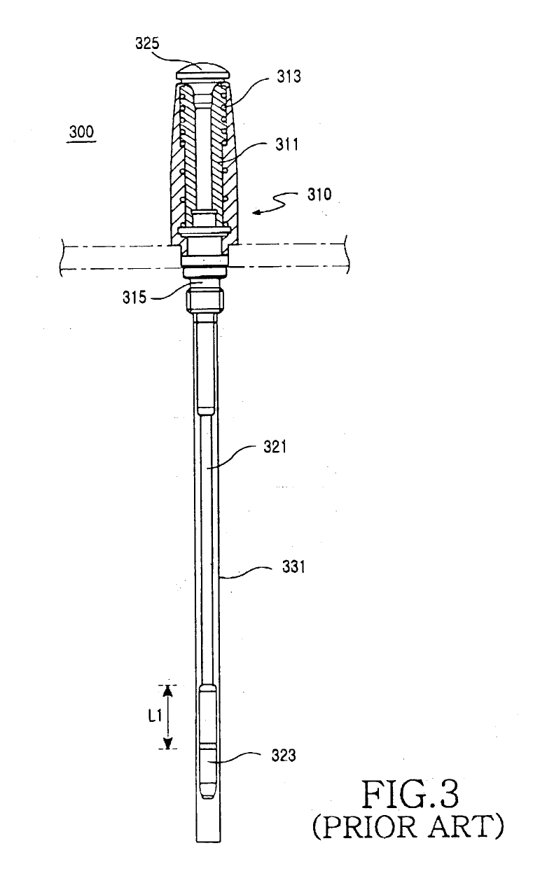

When the antenna device 300 of the prior art is compared with the antenna device 600 of the present invention, referring to FIGS. 3 and 6, it is apparent that the antenna dummy length L2 of the antenna device 600 according to the present invention is larger than the antenna dummy length L1 of the antenna device of the prior art.

Preferably, the antenna dummy 627 extends from the stopper 623 as a single body, and is made of a conductive material. The antenna dummy 627 may be plated with a substance such as nickel.

Because the antenna dummy 627 extends from the stopper 623, the reactance of the stopper 623 increases. In addition, when the whip antenna 621 is extended, the antenna gain increases due to capacitive coupling between the helical antenna 613 and the antenna dummy 627.

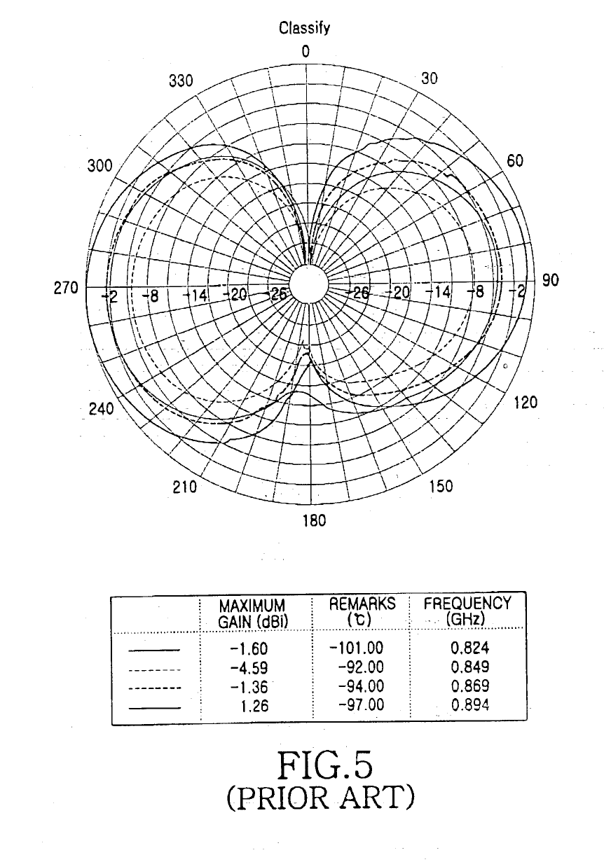

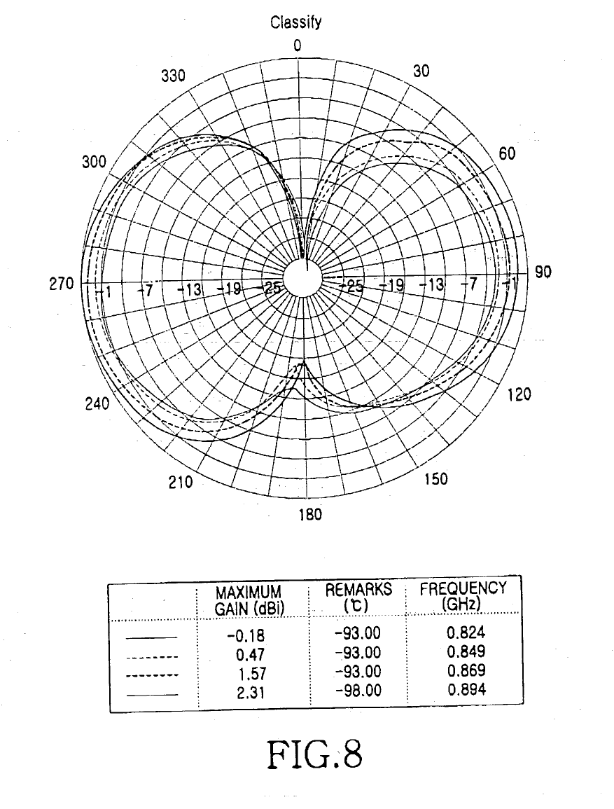

Antenna radiation characteristics after and before applying the antenna dummy 627 are described referring to graphs of FIGS. 5 and 8. FIG. 5 is a graph showing the radiation characteristics of the portable wireless terminal equipped with the antenna device 300 of the prior art that does not adopt the antenna dummy 627. FIG. 8 is a graph showing the radiation characteristics of the portable wireless terminal equipped with the antenna device 600 that adopts the antenna dummy 627 according to the present invention.

When the graphs of FIGS. 5 and 8 are compared with each other, it is found that the variation of antenna gains according to used frequencies is reduced after the antenna dummy 627 is applied. Such application is advantageous in that the maximum antenna gain is increased by about 1 dBi to 4 dBi according to the used frequencies.

The following Tables 1 and 2 provide comparisons of maximum and average gains of the prior art antenna device and the antenna device 600 equipped with the antenna dummy 627, according to the present invention.

Antenna gains shown in the following Tables 1 and 2 are results measured for a portable wireless terminal using a frequency band of 800 to 900 MHz and another portable wireless terminal using a frequency band of 1800 to 2000 MHz with their whip antennas extended.

TABLE 1

| Used | Prior Art | | Present Invention | | |
|---|---|---|---|---|---|
| Frequency | Maximum | Average | Maximum | Average | |
| (MHz) | Gain(dBi) | Gain(dBi) | Gain(dBi) | Gain(dBi) | Remarks |
| 824 | −2.27 | −3.66 | −0.36 | −1.75 | When antenna is |
| 849 | −4.57 | −5.95 | 0.31 | −1.15 | perpendicular |
| 869 | −1.39 | −2.67 | 1.26 | −0.29 | to ground |
| 894 | 1.28 | −0.4 | 2.1 | −0.1 | |
| 824 | −1.6 | −8.21 | −0.18 | −6.81 | When the rear of |
| 849 | −4.59 | −11.81 | 0.47 | −6.68 | terminal faces |
| 869 | −1.36 | −8.58 | 1.57 | −5.61 | toward ground |
| 894 | 1.26 | −5.9 | 2.31 | −4.79 | |
| 824 | −3.12 | −8.61 | −0.86 | −6.62 | When the side of |
| 849 | −4.92 | −10.78 | −0.43 | −6.47 | terminal faces |
| 869 | −1.68 | −7.69 | −0.6 | −5.57 | toward ground |
| 894 | 0.94 | −5.31 | 1.72 | −4.69 | |

TABLE 2

| Used | Prior Art | | Present Invention | | |
|---|---|---|---|---|---|
| Frequency | Maximum | Average | Maximum | Average | |
| (MHz) | Gain(dBi) | Gain(dBi) | Gain(dBi) | Gain(dBi) | Remarks |
| 1850 | −2.76 | −5.44 | −0.37 | −2.83 | When antenna is |
| 1910 | −2.39 | −4.99 | −0.74 | −3.42 | perpendicular |
| 1930 | −2.6 | −4.95 | −1.11 | −3.79 | to ground |
| 1990 | −2.25 | −4.94 | −1.26 | −3.75 | |
| 1850 | −3.71 | −10.53 | −1.39 | −7.36 | When the rear of |
| 1910 | −2.18 | −8.49 | −1.31 | −7.34 | terminal faces |
| 1930 | −2.36 | −8.39 | −1.88 | −7.78 | toward ground |
| 1990 | −2.68 | −7.51 | −1.82 | −7.04 | |
| 1850 | −2.05 | −9.35 | 0.78 | −5.52 | When the side of |
| 1910 | −0.27 | −7.35 | 0.51 | −5.62 | terminal faces |
| 1930 | −1.25 | −7.58 | −0.3 | −6.33 | toward ground |
| 1990 | −1.33 | −7.35 | −0.3 | −6.56 | |

As shown in Tables 1 and 2, it is found that the antenna gain of the portable wireless terminal according to the present invention is improved in both the maximum and average gains.

As apparent from the above description, an antenna device according to the present invention includes an antenna dummy extending from a stopper of a whip antenna that can be retracted into and extended from a terminal, whereby the reactance of the stopper is increased, and also capacitive coupling between the helical antenna and the stopper is provided to improve the antenna gain. This allows provision of a high quality antenna device even if the length of the antenna is restricted according to the miniaturization of the terminal.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An antenna device for a portable wireless terminal comprising:
an antenna housing including a helical antenna formed therein in a longitudinal direction of the antenna housing and having a perforating hole defined in the longitudinal direction of the helical antenna;
a whip antenna slidably retractable into and extendable from a terminal main body through the perforating hole;
a stopper formed on a bottom of the whip antenna to provide a connection point and restrict movement of the whip antenna when the whip antenna is fully extended; and
an antenna dummy extending from the stopper along an outer surface of the whip antenna in the longitudinal direction,
said antenna dummy being positioned in the helical antenna so as to face the helical antenna when the whip antenna is fully extended.

2. The antenna device as set forth in claim 1, wherein the antenna dummy extends to such a length that, when the whip antenna is fully extended, it extends from a bottom to a top of the helical antenna formed in the antenna housing.

3. The antenna device as set forth in claim 1, wherein the antenna dummy is made of a conductive material.

4. The antenna device as set forth in claim 1, wherein the stopper and the antenna dummy are plated with nickel.

5. The antenna device as set forth in claim 1, wherein the helical antenna is connected to an RF unit of the terminal through a connection end provided on a bottom of the antenna housing, and the stopper is connected to the connection end when the whip antenna is extended.
